(19) United States
(12) Patent Application Publication
(10) Pub. No.: US 2007/0046765 A1
(43) Pub. Date: Mar. 1, 2007

(54) IMAGE FORMING APPARATUS

(75) Inventors: Yuuzou KAWANO, Fukuoka (JP); Kouhei SUYAMA, Fukuoka (JP); Kazuo NISHIMURA, Fukuoka (JP); Kei SAKANOUE, Fukuoka (JP); Tetsurou NAKAMURA, Fukuoka (JP)

Correspondence Address: GREENBLUM & BERNSTEIN, P.L.C., 1950 ROLAND CLARKE PLACE, RESTON, VA, 20191, US

(73) Assignee: MATSUSHITA ELECTRIC INDUSTRIAL CO., LTD., Osaka (JP)

(21) Appl. No.: 11/467,985

(22) Filed: Aug. 29, 2006

(30) Foreign Application Priority Data
Aug. 29, 2005 (JP) 2005/247122

(51) Int. Cl. B41J 2/435

(52) U.S. Cl. 347/224

(57) ABSTRACT

In an image forming apparatus, comprising: an optical recording head having a light emitting element array including two or more sets of light emitting element blocks arranged in a line in a main scanning direction, each block including a given number of light emitting elements arranged in a line in the main scanning direction; and, a photo conductor exposable by the light from the optical recording head, the light emitting elements of the light emitting element blocks each having a slow light emitting timing are arranged such that they are shifted downstream in the sub scanning moving direction of the photo conductor according to the light emitting timings thereof with respect to the light emitting elements each having a fast light emitting timing.

### BACKGROUND OF THE INVENTION

1. Field of the Invention

The present invention relates to an image forming apparatus which uses an optical head including a light emitting element array as a light emitting source.

2. Description of the Related Art

Recently, an image forming apparatus including a light emitting array as a light emitting source has been widely put to practical use. Especially, a color image forming apparatus having two or more photo conductors as image carriers (which is hereinafter referred to as an image forming apparatus simply) has been put to practical use together with a conventional image forming apparatus of a type in which a copy is obtained by two or more rotations (for example, by four rotations), because it has an advantage in the productivity of the image formation thereof.

Now, FIG. 16 shows the schematic structure of a conventional image forming apparatus including two or more photo conductors. Specifically, this conventional image forming apparatus includes four photo conductors 101-104 and a transfer unit 105 extending over these photo conductors. In the peripheries of the respective photo conductors 101-104, there are disposed charging devices 106-109, exposure devices 110-113 serving as optical recording heads, developing devices 114-117, and photo conductor cleaning devices 118-121.

Developing agent storage parts 122-125 store therein toners for colors which respectively correspond to the developing devices 114-117, and the toners stored are supplied to their associated developing devices 114-117 in such a manner that the densities of images to be recorded on recording paper 128 are substantially constant.

The transfer unit 105 includes a belt-shaped transfer member 126, a drive roller 127 for rotationally moving the belt-shaped transfer member 126, a press roller 129 for pressing recording paper 128 against the belt-shaped transfer member 126, a support roller 130 situated on the opposite side to the drive roller 127 for receiving the pressing force of the press roller 129, and a tension roller 131 which applies a tensile force to the belt-shaped transfer member 126 to bring the belt-shaped transfer member 126 into contact with the photo conductors 101-104.

The belt-shaped transfer member 126 is a so called intermediate transfer member which carries the toner image onto the surface thereof and then transfers the toner image to the recording paper 128. However, the belt-shaped transfer member 126 may also be a so called recording paper delivery member which sucks the recording paper 128 onto a belt and then puts a toner image on the recording paper 128.

By the way, on the transfer unit 105, there is provided a belt cleaning device 132 for cleaning a so called remaining toner which is not transferred to the recording paper 128 but is left on the surface of the belt-shaped transfer member 126.

As shown in FIG. 16, the image forming apparatus comprises, besides the above-mentioned composing parts: a paper supply cassette 133 for storing the recording paper 128 therein; a paper supply part 138 composed of a paper supply roller 135, a pickup roller 136, resist rollers 137 and the like which are used to supply the recording paper 128 from the paper supply cassette 133 to a recording paper transfer part 134 composed of the support roller 130 and press roller 129; a fixing device 139 for fixing the toner image transferred onto the surface of the recording paper 128; and, other parts.

Next, description will be given below of the exposure devices 110-113 which are used as optical recording heads.

FIG. 17 is an enlarged partially broken perspective view of the exposure device 110. The other exposure devices 111-113 are the same in structure with the exposure device 110 and thus the description of the other exposure devices is omitted here.

In FIG. 17, a light emitting element array 140, which includes two or more organic EL elements as light emitting elements arranged in a line, is held within a long housing 141. The exposure device 110 serving as an optical recording head can be fixed at a given position of a box body (not shown) disposed opposed to the housing 141 in the following manner: that is, two positioning pins 142 respectively provided on the two ends of the housing 141 may be inserted into their associated positioning holes formed in the box body and screws may be then inserted into insertion holes 143 respectively formed in the two ends of the housing 141 to thereby fix the exposure device 110 to the box body.

The exposure device 110 includes two or more light emitting elements 150 which are formed on a glass substrate 144 and constitute the light emitting element array 140; and, the light emitting elements 150 can be respectively driven for light emission by TFTs 151 (see FIG. 19) formed on the same glass substrate 144, while the TFTs 151 will be described later. A graded index type rod lens array 146 serving as a lens array is formed in front of the light emitting elements 150 in such a manner that two or more graded index rod lenses 147 are arranged in a straw bags piling manner.

The housing 141 encloses the periphery of the glass substrate 144 while the side of the housing 141 facing the photo conductor 101 is open. The light of the light emitting element 150 is radiated onto the photo conductor 101 through the graded index type rod lens 147. The surface of the housing 141 facing the end face of the glass substrate 144 is formed of a light absorbing material (paint).

Now, FIG. 18 is a section view of the exposure device 110, taken along the surface thereof extending in the sub scanning direction (in the sub scanning moving direction of the photo conductor 101). The exposure device 110 includes the light emitting element array 140 mounted so as to face the rear surface of the graded index type rod lens array 146 within the housing 141, and an opaque cover 148 for shielding the light emitting element array 140 from the back surface of the housing 141.

Also, the cover 148 is pressed against the back surface of the housing 141 by a fixed plate spring 149 to thereby seal the inside of the housing 141 in a light tight manner. That is, the glass substrate 144 is optically sealed by the housing 141 and cover 148 due to the fixed plate spring 149. The fixed plate spring 149 is engaged with two or more portions of the housing 141 in the longitudinal direction thereof.

Since the housing 141 of the exposure device 110 is formed of an opaque member and the back surface of the housing 141 is covered with the opaque cover 148, ultraviolet rays entering the back surface of the light emitting element array 140 from a fluorescent lamp or the sun can be prevented from reaching the light emitting elements 150 of the light emitting element array 140.

Now, FIG. 19 is a section view of the structure of the neighboring portion of the light emitting element 150 of the light emitting element array 140. In the light emitting element array 140, on the glass substrate 144 having a thickness of 0.5 mm, there are arranged the TFTs (thin-film transistors) 151 each made of poly-silicone and having a thickness of 50 nm for controlling the light emission of the light emitting elements 150, while the TFTs 151 respectively correspond to their associated light emitting elements 150 arranged in a line but are situated outside such line.

On the glass substrate 144, there is formed an insulating film 152 made of SiO₂ and having a thickness of the order of 100 nm except for a contact hole formed on the TFT 151 and, on the insulating film 152 of the light emitting element 150, there is formed an anode 153 made of ITO and having a thickness of the order of 50 nm in such a manner that it can be connected to the TFT 151 through the contact hole on the insulating film 152 existing in the periphery of the light emitting element 150, there is formed another insulating film 154 made of SiO₂ and having a thickness of the order of 120 nm; and, on the insulating film 154, there is formed a bank 156 made of polyimide and having a thickness of 2 μm in which there is formed a hole 155 corresponding to the light emitting element 150.

In the hole 155 of the bank 156, sequentially in the order starting from the anode 153 side, there are formed a hole injection layer 157 having a thickness of 50 nm and a light emitting layer 158 having a thickness of 50 nm. And, there are sequentially formed a cathode first layer 159a made of Ca and having a thickness of 100 nm and a cathode second layer 159b made of Al and having a thickness of 200 nm in such a manner that they cover the top surface of the light emitting layer 158, the inner surface of the hole 155 and the outer surface of the bank 156.

A space existing upwardly of the bank 156 is covered with a cover glass 161 having a thickness of the order of 1 mm, and inert gas 160 such as nitrogen gas is inserted into between the glass substrate 144 and cover glass 161. The light emitting element 150 of the light emitting element array 140 is structured in the above-mentioned manner. The light emitted by the light emitting element 150 is radiated onto the glass substrate 144.

Now, FIG. 20 is a block diagram of the schematic structure of the control part of the light emitting element array. A host computer 163 creates print data and transmits them to the control part 164 of the image forming apparatus. The control part 164 of the image forming apparatus includes data processing means 165, memory means 166-169, and light emitting line heads (which are hereinafter referred to as “light emitting element arrays”) 162, 171, 172, 173.

The light emitting element arrays 162, 171, 172 and 173 respectively correspond to yellow, magenta, cyan and black and they form a color image on the surface of a photo conductor. The memory means 166-169 respectively store therein image data which correspond to the light emitting element arrays 162, 171, 172 and 173 for the respective colors.

The data processing means 165, based on the print data transmitted from the host commuter 163, executes processings including a color separation processing, a tone processing, a processing for developing the image data to a bit map, a color gap adjusting processing and the like. The data processing means 165 outputs the image data for each line to the respective memory means 166-169.

FIG. 21 is an explanatory view of the light emitting element array 162 for yellow shown in FIG. 20. In the light emitting element array 162, there are arranged two or more light emitting elements in a line in the Y direction of FIG. 21 which is a main scanning direction. The light emitting element array 162 is composed of two or more sets of light emitting element blocks 162a-162n arranged in a line in the main scanning direction. Within the light emitting element block 162a, there are arranged eight light emitting elements 162a1-162a8 are arranged in a line. Within each of the remaining light emitting element blocks 162b-162n as well, there are arranged eight light emitting elements in a line.

FIG. 22 is a block diagram of the details of the drive emitting element array 162 for yellow.

The memory means 166 shown in FIG. 20 has a function to transfer and hold image data with respect to the light emitting element array 162. The data processing means 165 outputs image data for each line to the memory means 166. The image data transferred from the memory means 166 allow the respective light emitting elements 162a1-162n8 of the light emitting element array 162 to emit the lights thereof using a driver IC and a gate controller.

The light emitting timings of the respective light emitting elements differ according to the arrangement order of the light emitting elements within the respective light emitting element blocks 162a-162n; for example, the light emitting elements 162a1-162n1 firstly emit their lights simultaneously and, in the next timing, the light emitting elements 162a2-162n2 emit their lights simultaneously.

Next, description will be given below of a toner image to be formed on the photo conductor by the light emitting elements arranged linearly in a line as shown in FIGS. 21 and 22 with reference to FIG. 23. Here, for easy understanding of the description, as an example, there is taken a case in which all elements are allowed to emit their lights. In FIG. 23, the first dot shows toner images 174a1-174n1 formed on a photo conductor 1 by the light emitting elements 162a1-162n1 which have emitted their lights at the first timing within the respective light emitting element blocks 162a-162n.

The third dot shows toner images 174a1-174n3 formed on the photo conductor by the light emitting elements 162a1-162n3 which have emitted their lights by the third timing within the respective light emitting element blocks 162a-162n. The eighth dot shows toner images 174a1-174n8 formed on the photo conductor by the light emitting elements 162a1-162n8 which have emitted their lights by the eighth timing (last timing) within the respective light emitting element blocks 162a-162n.

The images exposed on the photo conductor in the above-mentioned manner are not arranged linearly as the toner images on the photo conductor but, for example, between the toner images 174a8 and 174b1 which are toner images formed by the light emitting elements 162a8 and 162b between the light emitting element blocks, there are formed toner images which are different in level.

In order that the toner images to be formed on the photo conductor by the light emitting elements respectively arranged in a linear manner can be arranged in a linear manner, the light emitting timings of all light emitting elements must be made simultaneous.

Japanese Patent Publication 2002-361924 is disclosed as the related art.

However, in the conventional image forming apparatus, the respective light emitting elements must be driven independently and thus, when the light emitting timings of all light emitting elements are made simultaneous, under the existing circumstances, the cost of the driver IC increases, which results in the increased cost of the exposure device.

### SUMMARY OF THE INVENTION

The present invention is made in view of the above circumstances of the conventional image forming apparatus. Thus, it is an object of the invention to provide an image forming apparatus which, when forming images on photo conductors by two or more light emitting elements arranged in a line in a main scanning direction, can prevent toner images to be formed from being strained and thus can provide high quality images at a reduced cost.

In solving the above-mentioned problems and attaining the above object of the invention, according to the invention, there is provided an image forming apparatus, comprising: an optical recording head having a light emitting element array including two or more sets of light emitting element blocks arranged in a main scanning direction, each block including two or more electroluminescent elements; and, a photo conductor exposable by the light from the optical recording head, wherein the electroluminescent elements are arranged to be shifted to a sub scanning direction of the photo conductor within the light emitting element blocks; and the emitting timing of the electroluminescent elements provided in downstream in the sub scanning direction is controlled so as to be delayed from the emitting timing of the electroluminescent elements provided in upstream in the sub scanning direction.

According to the image forming apparatus of the invention, toner images on the photo conductor can be formed in a linear manner, thereby being able to provide an image forming apparatus which can prevent the strained toner images, can be produced at a low cost and can provide high quality images.

### BRIEF DESCRIPTION OF THE DRAWINGS

FIG. 1 is a view of the schematic structure of an image forming apparatus according to a mode for carrying out the invention.

FIG. 2 is a partially broken enlarged perspective view of an exposure device.

FIG. 3 is a section view of an exposure device, taken along the surface thereof in a sub scanning direction.

FIG. 4 is a section view of the structure of the neighboring portion of the light emitting element of a light emitting element array.

FIG. 5 is a block view of the schematic structure of the control part of a light emitting element array.

FIG. 6 is a view of a light emitting element array according to an embodiment 1.

FIG. 7 is a block view of the details of the respective element drive means of a light emitting element array.

FIG. 8 is an explanatory view of toner images formed on a photo conductor by the light emitting element array according to the embodiment 1.

FIG. 9 is a view of a light emitting element array according to an embodiment 2.

FIG. 10 is a view of a light emitting element array according to an embodiment 3.

FIG. 11 is a view of toner images formed on a photo conductor by the light emitting element array according to embodiment 3,

FIG. 12 is a view of a light emitting element array according to an embodiment 4.

FIG. 13 is a block diagram of the schematic structure of the control part of the light emitting element array according to the embodiment 4.

FIG. 14 is a view of toner images formed on a photo conductor by the light emitting element array according to the embodiment 4.

FIG. 15 is a view of the position relationship between the lens array of an optical recording head and a light emitting element array.

FIG. 16 is a view of the schematic structure of a conventional image forming apparatus including two or more photo conductors.

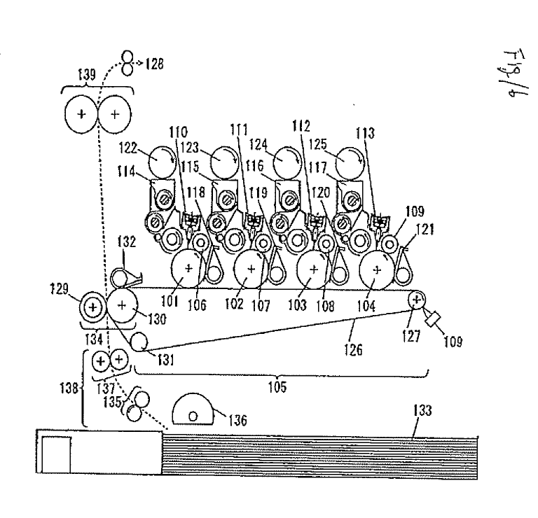

FIG. 17 is a partially broken enlarged perspective view of an exposure device.

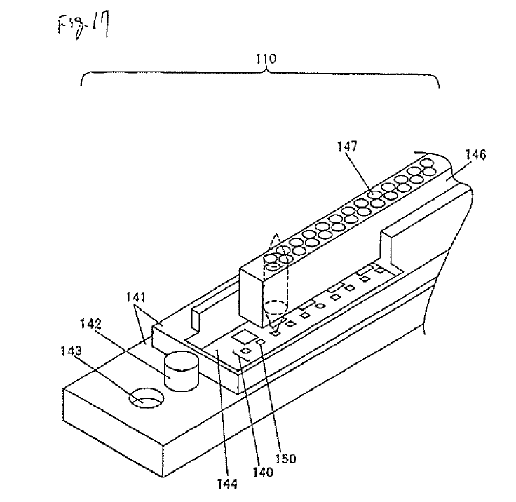

FIG. 18 is a section view of an exposure device, taken along the surface thereof in a sub scanning direction.

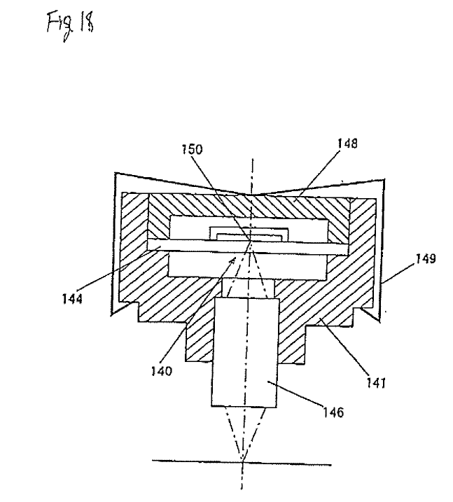

FIG. 19 is a section view of the structure of the neighboring portion of the light emitting element of a light emitting element array.

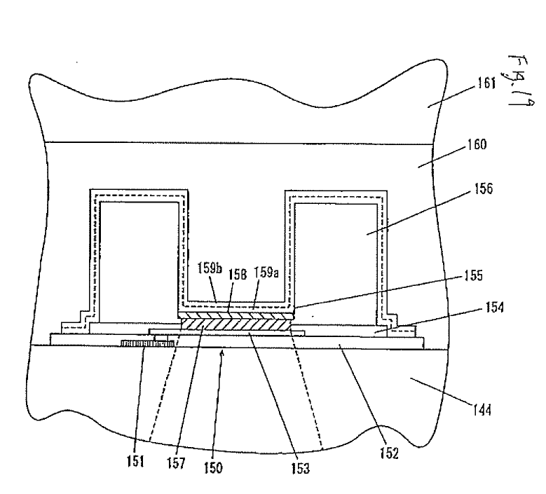

FIG. 20 is a block view of the schematic structure of the control part of a light emitting element array.

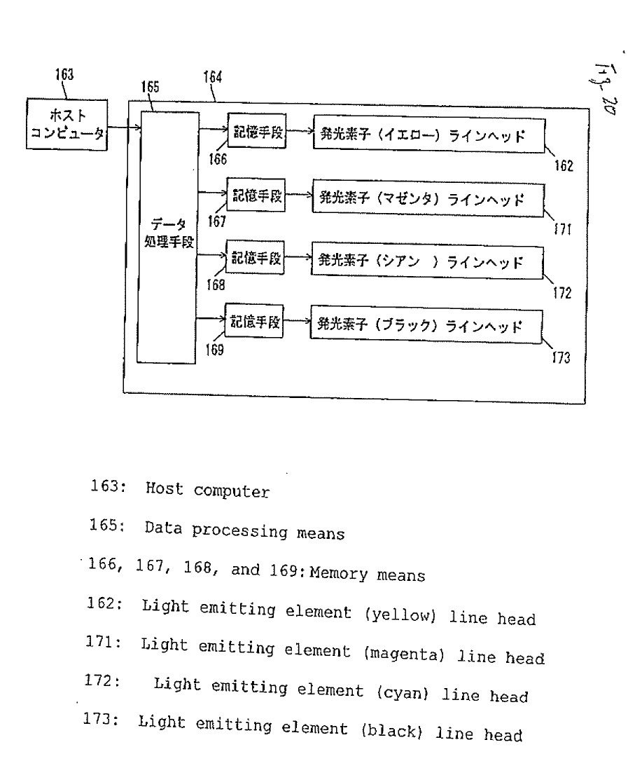

FIG. 21 is an explanatory view of a light emitting element array for yellow.

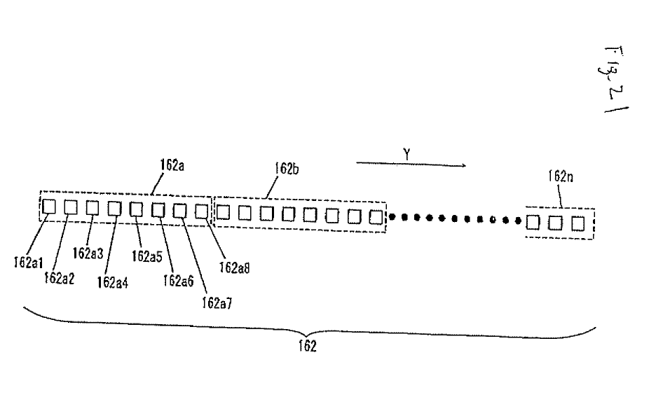

FIG. 22 is a block diagram of the details of the drive means of the respective light emitting elements of a light emitting element array.

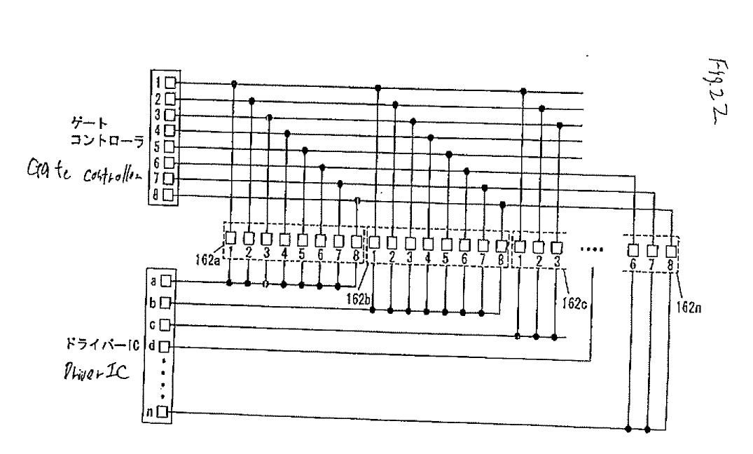

FIG. 23 is a view of toner images formed on a photo conductor by a conventional light emitting element array.

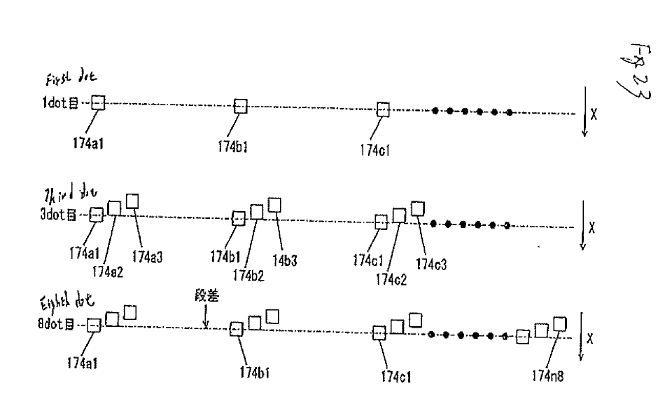

### DESCRIPTION OF THE PREFERRED EMBODIMENTS

According to the invention as set forth in claim 1, there is provided an image forming apparatus, comprising, an optical recording head having a light emitting element array including two or more sets of light emitting element blocks arranged in a main scanning direction, each block including two or more electroluminescent elements; and, a photo conductor exposable by the light from the optical recording head, wherein the electroluminescent elements are arranged to be shifted to a sub scanning direction of the photo conductor within the light emitting element blocks, and the emitting timing of the electroluminescent elements provided in downstream in the sub scanning direction is controlled so as to be delayed from the emitting timing of the electroluminescent elements provided in upstream in the sub scanning direction. Thus, the present invention can prevent the occurrence of the strained toner images, thereby being able to prevent the images from being deteriorated in quality.

According to the invention as set forth in claim 2, there is provided an image forming apparatus as set forth in claim 1, wherein, with respect to the electroluminescent elements arranged in one end portion of each of the light emitting blocks, the other remaining electroluminescent elements are arranged shifted downstream in the sub scanning moving direction of the photo conductor in such a manner that the downstream shifting amounts thereof increase as the arrangement positions thereof are nearer to the other end portion of each of the blocks. Therefore, the present invention can prevent the occurrence of the strained toner images, thereby being able to prevent images from being deteriorated in quality.

According to the invention as set forth in claim 3, there is provided an image forming apparatus as set forth in claim 1, wherein, with respect to the electroluminescent elements arranged in the two end portions of each of the light emitting element block, the electroluminescent elements arranged in the central portion of each block are disposed shifted downstream in the sub scanning moving direction of the photo conductor. Therefore, according to the present invention, since the light emitting timings of the electroluminescent elements between the mutually adjoining light emitting element blocks are very near to each other, the toner image level difference between the light emitting element blocks can be reduced, thereby being able to obtain toner images which are arranged in a straight line and are higher in precision.

According to the invention as set forth in claim 4, there is provided an image forming apparatus as set forth in claim 1, wherein, with respect to the electroluminescent elements arranged in the central portion of each of the light emitting element blocks, the electroluminescent elements arranged in the two end portions of each block are disposed shifted downstream in the sub scanning moving direction of the photo conductor. Thus, according to the present invention, since the light emitting timings of the electroluminescent elements between the mutually adjoining light emitting element blocks are very near to each other, the toner image level difference between the electroluminescent element blocks can be reduced, thereby being able to obtain toner images which are arranged in a straight line and are higher in precision.

According to the invention as set forth in claim 5, there is provided an image forming apparatus as set forth in any one of claims 1 to 4, wherein the amount of mutual shifting in the sub scanning moving direction of the photo conductor between the electroluminescent elements of each light emitting element block adjoining each other in the light emitting timing order is set for a value obtained when a pitch between the electroluminescent elements adjoining each other in a main scanning direction is divided by the number of the electroluminescent elements arranged within the light emitting element block. Thanks to this, lags between the light emitting timings of the electroluminescent elements can be made coincident with the shifting amounts of the toner images due to the movement of the photo conductor, thereby being able to prevent images from being deteriorated in quality.

According to the invention as set forth in claim 6, there is provided an image forming apparatus as set forth in any one of claims 1 to 4, wherein the amount of mutual shifting in the sub scanning moving direction of the photo conductor between the electroluminescent elements of each of the light emitting element blocks adjoining each other in the light emitting timing is set for a distance to be covered by the photo conductor when the photo conductor moves in the sub scanning moving direction between the light emitting timings of the electroluminescent elements. Thanks to this, the lags between the light emitting timings of the electroluminescent elements can be made coincident with the shifting amounts of the toner images due to the movement of the photo conductor, thereby being able to prevent images from being deteriorated in quality.

According to the invention as set forth in claim 7, there is provided an image forming apparatus as set forth in claim 6, wherein the photo conductor has two or more moving speed modes and the amount of mutual shifting in the sub scanning moving direction of the photo conductor between the electroluminescent elements of each of the light emitting element blocks adjoining each other in the light emitting timing order is set for a distance to be covered by the photo conductor when the photo conductor moves in the sub scanning moving direction in the slowest moving speed mode. According to the present invention, toner images in the highest resolving power mode of the image forming apparatus can be made free from stain.

According to the invention as set forth in claim 8, there is provided an image forming apparatus as set forth in claim 6, wherein the photo conductor has two or more moving speed modes and the amount of mutual shifting in the sub scanning moving direction of the photo conductor between the electroluminescent elements of each of the light emitting element blocks adjoining each other in the light emitting timing order is set for a distance to be covered by the photo conductor when the photo conductor moves in the sub scanning moving direction for a time between the light emitting timings of the electroluminescent elements in a moving speed mode intermediate between the slowest and fastest moving speed modes. According to the present invention, an image deterioration difference between a standard resolving power mode and a highest resolving power mode can be minimized. According to the invention as set forth in claim 9, there is provided an image forming apparatus as set for the in claim 6, wherein the photo conductor has two or more moving speed modes and the optical recording head includes two or more light emitting arrays respectively corresponding to the two or more moving speed modes of the photo conductor. According to the present invention, in the respective moving speed modes, there can be obtained toner images which are free from strain.

According to the invention as set forth in claim 10, there is provided an image forming apparatus as set forth in claim 3 or 4, wherein the light emitting arrays are arranged in a sine curve manner. Thus, according to the present invention, since the light emitting timings of the electroluminescent elements between the mutually adjoining light emitting element blocks are very near to each other, the toner image level difference between the light emitting element blocks can be reduced, thereby being able to obtain toner images which are arranged in a straight line and are higher in precision. According to the invention as set forth in claim 11, there is provided an image forming apparatus as set forth in any one of claims 1 to 10, further including a lens array for condensing the light from the light emitting array, wherein the center line of the lens array in the main scanning direction is coincident with the center line of the light emitting element array. According to the present invention, the shifting amount of the light emitting element in the sub scanning direction of the photo conductor with respect to a lens can be minimized, thereby being able to prevent images from being deteriorated in quality.

According to the invention as set forth in claim 12, there is provided an image forming apparatus, comprising: an optical recording head having a light emitting array with two or more sets of light emitting element blocks arranged in a main scanning direction therein, each block including two or more electroluminescent elements; and, a photo conductor exposable to the light from the optical recording head, wherein the respective electroluminescent elements in one end portion of each of the two or more light emitting element blocks are arranged on a straight line in the main scanning direction, and the other remaining electroluminescent elements than the electroluminescent elements in one end portion of each block are arranged shifted in the sub scanning moving direction of the photo conductor according to lags between the light emitting timings of the respective electroluminescent elements. According to the present invention, toner images can be prevented from being strained, which makes it possible to prevent the quality deterioration of images.

According to the invention as set forth in Claim 13, there is provided an image forming apparatus, comprising: an optical recording head having a light emitting array with two or more sets of light emitting element blocks arranged in a main scanning direction therein, each block including two or more electroluminescent elements; and, a photo conductor exposable to the light from the optical recording head, wherein the respective electroluminescent elements in the central portion of each of the two or more light emitting element blocks are arranged on a straight line in the main scanning direction, and the other remaining electroluminescent elements than the electroluminescent elements in the central portion of each block are arranged shifted in the sub scanning moving direction of the photo conductor according to lags between the light emitting timings of the respective electroluminescent elements. According to the present invention as well, toner images can be prevented from being strained, which makes it possible to prevent the quality deterioration of images.

According to the invention as set forth in claim 14, there is provided an image forming apparatus as set forth in any one of claims 1, 12 and 13, wherein the two or more light emitting element blocks are formed collectively on a given substrate. According to the present invention as well, toner images can be prevented from being strained, which makes it possible to prevent the quality deterioration of images.

Now, description will be given below of a mode for carrying out the invention with reference to the accompanying drawings.

### Embodiment 1

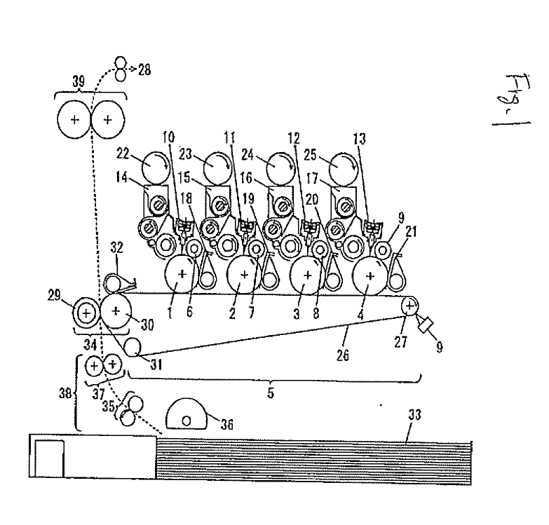

FIG. 1 is a schematic structure view of an image forming apparatus including two or more photo conductors according to an embodiment of the invention. The image forming apparatus according to the present embodiment comprises four photo conductors 1-4 and a transfer unit 5 which extends over these photo conductors. In the peripheries of the respective photo conductors 1-4, there are disposed charging devices 6-9, exposure devices 10-13 respectively acting as optical recording heads, developing devices 14-17, and photo conductor cleaning devices 18-21, respectively.

Developing agent storage parts 22-25 respectively store therein toners for colors respectively corresponding to the developing devices 14-17, and the toners stored therein are supplied to their associated developing devices 14-17 in such a manner that the densities of images to be recorded on paper can be made substantially constant.

The transfer unit 5 comprises a belt-shaped transfer member 26, a drive roller 27 used to rotate and move the belt-shaped transfer member 26, a press roller 29 for pressing recording paper 28 against the belt-shaped transfer member 26, a support roller 30 positioned on the opposite side to the drive roller 27 for receiving the pressing force of the press roller 29, and a tension roller 31 for applying a tensile force to the belt-shaped transfer member 26 to thereby bring the belt-shaped transfer member 26 into contact with the photo conductors 1-4.

The belt-shaped transfer member 26 is a so called intermediate transfer member which puts toner images directly onto the surface thereof and then transfers the toner images onto the recording paper 28. However, the belt-shaped transfer member 26 may also be a so called recording paper delivery member which sucks up the recording paper 28 onto a belt and puts toner images onto the recording paper 28.

By the way, on the transfer unit 5, there is provided a belt cleaning device 32 for cleaning so called remaining toners which have not been transferred to the recording paper 28 but have been left on the surface of the belt-shaped transfer member 26.

As shown in FIG. 1, the present image forming apparatus, besides the above-mentioned components, further includes: a paper supply part 38 which is composed of a paper supply cassette 33 for storing the recording paper 28 therein, a paper supply roller 35 for supplying the recording paper 28 from the paper supply cassette 33 to a recording paper transfer part 34 composed of the support roller 30 and press roller 29, a pickup roller 36, a resist roller 37 and the like; a fixing device 39 for fixing toner images which have been transferred to the surface of the recording paper 28; and the like.

Next, description will be given below of a method for forming an image when the belt-shaped transfer member 26 is an intermediate transfer member. Firstly, after the photo conductor 1 is uniformly charged by the charging device 6, the photo conductor 1 is exposed by the exposure device 10, whereby an electrostatic latent image formed on the photo conductor 1 is developed using a single color toner. A toner image, which is a visualized version of an electrostatic latent image, is transferred to the belt-shaped transfer member 26 at a position where the photo conductor 1 comes into contact with the belt-shaped transfer member 26.

To a timing at which the first toner image advances to the position for contact with the photo conductor 2, similarly to the first toner, another toner image formed on the surface of the photo conductor 2 and having a different color from the color of the first toner is transferred on top of the first toner image as a second toner image. From now on, similarly, third and fourth images are superimposingly transferred, thereby completing a four color superposed image.

The superposed images formed on the belt-shaped transfer member 26 are then collectively transferred in the recording paper transfer part 34 composed of the support roller 30 and press roller 29, and are fixed on the recording paper 28 by the fixing device 39, thereby forming a color image on the recording paper 28.

The image forming apparatus according to the embodiment 1 is different from the above-mentioned conventional image forming apparatus in the structure of the exposure devices 10-13 respectively act as optical recording heads. In the embodiment 1, there is used an optical recording head in which organic electroluminescent elements (which are hereinafter referred to as light emitting elements, unless a specific explanation is necessary) are arranged in a nonlinear manner in the main scanning direction of the photo conductor 1. The optical recording head using a light emitting element array is advantageous when compared with a recording head of a laser scan optical system in that the optical path length thereof is short, it is compact, it can be disposed near to the photo conductor 1, and can reduce the size of the whole image forming apparatus.

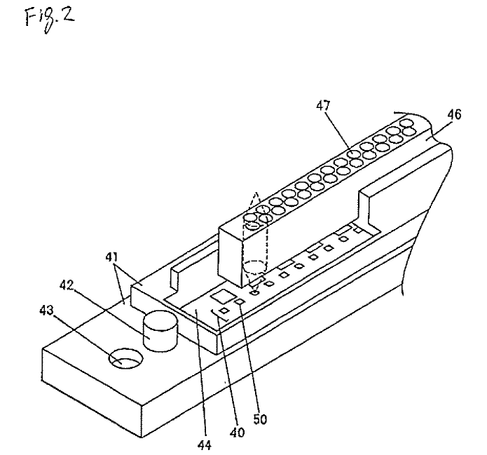

FIG. 2 is a partially broken enlarged perspective view of the exposure device 10 used as an optical recording head. As for the remaining exposure devices 11-13, they are the same in structure as the exposure device 10 and thus the description thereof is omitted here.

A light emitting element array 40, in which two or more organic EL elements serving as light emitting elements are arranged in a line, is held within a long housing 41. The exposure device 10 serving as an optical recording head can be fixed at a given position of a box body (not shown) disposed opposed to the housing 41 in such a manner that two positioning pins 42 respectively provided on the two ends of the housing 41 are inserted into their associated positioning holes formed in the box body and two screws are respectively inserted into two screw insertion holes 43 to thereby fix the exposure device 10.

The exposure device 10 includes two or more light emitting elements 50 of the light emitting element array 40 formed on a glass substrate 44, and the light emitting elements 50 can be driven for light emission by their associated TFTs 51 (which will be discussed later) formed on the same glass substrate 44. A graded index type rod lens array 46 serving as a lens array is formed in front of the light emitting elements 50 in such a manner that graded index type rod lenses 47 are arranged in a straw bag piling manner.

The housing 41 encloses the periphery of the glass substrate 44 and the side of the housing 41 facing the photo conductor 1 is open. The lights of the light emitting elements 50 are radiated onto the photo conductor 1 through the graded index type rod lenses 47. The surface of the housing 41 facing the end face of the glass substrate 44 is made of a light absorbing material (paint).

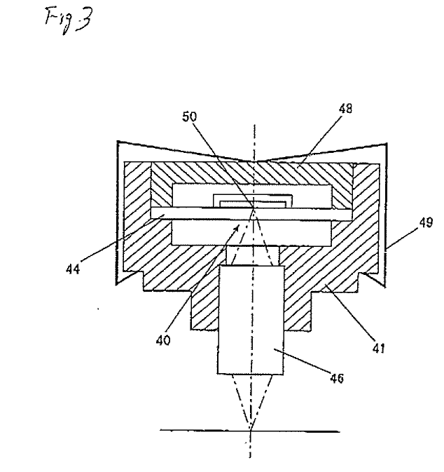

FIG. 3 is a section view of the exposure device 10, taken along the surface thereof in the sub scanning direction (the sub scanning moving direction of the photo conductor 1). The exposure device 10 includes the light emitting array 40 mounted facing the rear surface of the graded index type rod lens array 46 within the housing 41 and an opaque cover 48 for shielding the light emitting element array 40 from the back surface of the housing 41.

Also, the cover 48 is pressed against the back surface of the housing 41 by a fixed plate spring 49 to thereby seal the inside of the housing 41 in a light tight manner. That is, the glass substrate 44 is optically sealed with the housing 41 and cover 48 using the fixed plate spring 49. The fixed plate spring 49 is engaged with the housing 41 at two or more portions thereof in the longitudinal direction thereof.

Since the housing 41 of the exposure device 10 is made of an opaque member and the back surface thereof is covered with the opaque cover 48, ultraviolet rays from a fluorescent lamp and the sun entering the back surface of the light emitting element array 40 can be prevented from reaching the light emitting elements 50 of the light emitting element array 40.

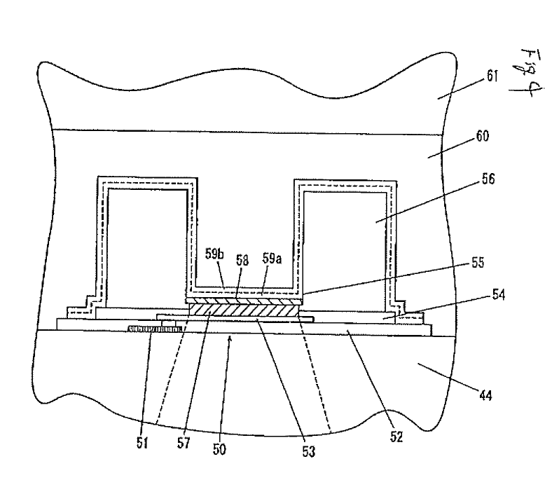

FIG. 4 is a section view of the structure of the portion of the light emitting element array 40 that exists in the vicinity of the light emitting element 50. In the light emitting element array 40, there are disposed on the glass substrate 44 having a thickness of 0.5 mm TFTs (thin film transistors) 51 each having a thickness of 50 nm for controlling the light emission of their associated light emitting elements 50 in such a manner that they respectively correspond in position to their associated light emitting elements 50 arranged in a line but are situated outside the arrangement line of the light emitting elements 50. On the glass substrate 44, except for contact holes formed on the TFTs 51, there is formed an insulating film 52 which is made of SiO₂ and has a thickness of the order of 100 nm; and, in order that each light emitting element 50 can be connected to its associated TFT 51 through the contact hole, on the insulation film 52 of the light emitting element 50, there is formed an anode 53 which is made of ITO and has a thickness of 50 nm.

On the insulating film 52 in the periphery of the light emitting element 50, there is formed another insulating film 54 made of SiO₂ and having a thickness of the order of 120 nm and, on the insulating film 54, there is provided a bank 56 which is made of polyimide, has a thickness of 2 μm and includes a hole 55 corresponding to its associated light emitting element 50.

Within the hole 55 of the bank 56, in the order starting from the anode 53, there are formed a hole injection layer 57 having a thickness of 50 nm and a light emitting layer 58 having a thickness of 50 nm; and, in order that the top surface of the light emitting layer 58, the inner surface of the hole 55 and the outer surface of the bank 56 can be covered, there are formed a cathode first layer 59a made of Ca and having a thickness of 100 nm, and a cathode second layer 59b made of Al and having a thickness of 200 nm sequentially in this order.

A space existing upwardly of the bank 56 is covered with a cover glass 61 having a thickness of the order of 1 mm and inert gas 60 such as nitrogen gas is charged into between the glass substrate 44 and cover glass 61. Each of the light emitting elements 50 of the light emitting element array 40 is structured in the above-mentioned manner. The light emitted from the light emitting element 50 is radiated onto the glass substrate 44.

By the way, with regards to the material for the light emitting layer 58 and the material for the hole injection layer 57, there can be used various known materials, for example, the materials which have been disclosed in Japanese Patent Publication Hei-10-12377, Japanese Patent Publication 2000-323276 and the like and thus the detailed description thereof is omitted here, Since such organic EL elements can be formed easily on the glass substrate, the manufacturing costs of the layers can be reduced.

As has been already described, in the embodiment 1, the light emitting elements 50 constituting the light emitting element array 40 are organic electroluminescent elements. Although the light emitting elements 50 are formed according to the above-mentioned process, to form the banks 56 for regulating the light emitting areas of the respective light emitting elements 50, basically, through an exposure process and an etching process using a single photo mask, the banks 56 are formed collectively for the whole of the light emitting elements 50. Thanks to this, light emitting element blocks (which will be discussed later) each composed of two or more light emitting elements 40 can also be collectively formed on a substrate.

Therefore, when compared with a conventionally frequently used method in which a large number of LED tips each with two or more light emitting elements formed thereon are fixed onto a substrate using an adhesive or the like, the precision of the arrangement positions of the respective light emitting elements 50 and light emitting element blocks can be enhanced very greatly.

The LED tips, normally, are arranged mechanically using a manufacturing device such as a tip mounting device and the precision of the tip arrangement position is regarded as, for example, ±5 μm or so (which is a so called tip level difference). On the other hand, in the case of the organic electroluminescent elements which are manufactured through a thin film process, the precision of the arrangement position of the light emitting elements 50 and light emitting element blocks depends mainly on the precision of the photo mask and, therefore, the precision thereof is equal to or less than ±0.5 μm. In other words, in the light emitting element array 40 using the organic electroluminescent elements, principally, there is no possibility that the tip level difference can occur.

Thus, since the precision of the arrangement position of the light emitting elements 50 and light emitting element blocks is enhanced greatly, as will be hereinafter described in detail, when the light emitting elements 50 are arranged in a non-linear manner in the light emitting element blocks while they are shifted from each other, the greatest advantage can be obtained.

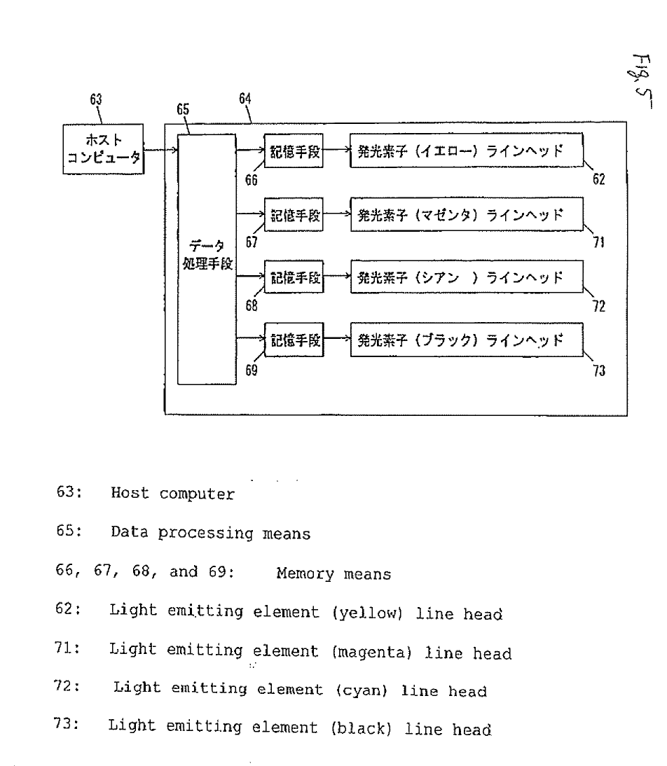

FIG. 5 is a block view of the schematic structure of the control part of the light emitting element array. A host computer 63 creates print data and transmits them to the control part 64 of the image forming apparatus. The control part 64 of the image forming apparatus includes data processing means 65, memory means 66-69, and light emitting element arrays 62, 71, 72, 73.

The light emitting element arrays 62, 71, 72 and 73 respectively correspond to yellow, magenta, cyan and black, and cooperate together in forming a color image on the surface of the photo conductor. The memory means 66-69 store therein image data corresponding to the light emitting element arrays 62, 71, 72 and 73 for the respective colors.

The data processing means 65, based on the print data transmitted from the host computer 63, carries out various processings including a color separation processing, a tone processing, a processing for developing image data to a bit map, a shifted color adjusting processing and the like. The data processing means 65 outputs image data for each line to the respective memory means 66-69.

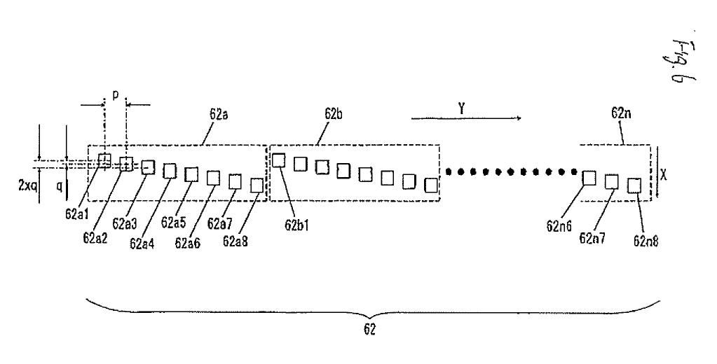

FIG. 6 is an explanatory view of the light emitting element array 62 for yellow according to the embodiment 1. In the light emitting element array 62, there are arranged two or more light emitting elements in the Y direction of FIG. 6 which is the main scanning direction of the photo conductor 1. The light emitting element array 62 is composed of two or more sets of light emitting element blocks 62a-62n.

Within the light emitting element block 62a, there are arranged eight light emitting elements 62a1-62a8 in such a manner that, with respect to the light emitting element 62a1 arranged in one end portion of the light emitting element block 62a, the remaining light emitting elements are shifted downstream in the sub scanning moving direction X of the photo conductor 1 while the shifting amounts thereof increase as the arranged positions thereof approach the other end portion of the block 62a. A pitch q between the light emitting elements in the X direction which is the sub scanning moving direction of the photo conductor 1 is set for a value which can be obtained when a pitch p between the light emitting elements in the main scanning direction Y of the photo conductor 1 is divided by 8, namely, the number of light emitting elements within the light emitting element block 62a.

The respective light emitting elements 62a1-62n1 in the respective one-end portions of the two or more light emitting element blocks 62a-62n are arranged on a straight line in the main scanning direction Y, whereas the other remaining light emitting elements 62a2-62n8 than the above-mentioned light emitting elements in the respective one-end portions are arranged shifted in the sub scanning moving direction of the photo conductor 1 according to lags (which will be described later) between the light emitting timings (that is, start timing of lighting) of the respective light emitting elements. As described later in detail, in the image forming apparatus according to the embodiment 1, the forming image by exposing the photo conductor 1 are arranged to be shifted to a sub scanning direction of the photo conductor 1 within the light emitting element blocks and the emitting timing of the light emitting elements 50 (electroluminescent elements) provided in downstream in the sub scanning direction is controlled so as to be delayed from the emitting timing of the electroluminescent elements (electroluminescent elements) provided in upstream in the sub scanning direction.

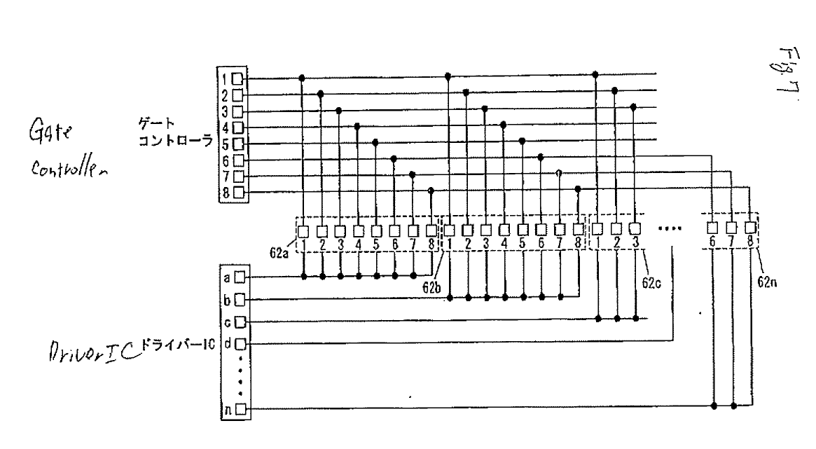

Now, FIG. 7 is a block diagram of the details of the respective drive means of the light emitting element array 62 for yellow shown in FIG. 6. The memory means 66 shown in FIG. 5 transfers image data to the light emitting element array 62 and also holds such image data for the latter. The data processing means 65 outputs image data for each line to the memory means 66. The image data transferred from the memory means 66 allow the respective light emitting elements 62a1-62n8 of the light emitting element array 62 to emit their lights through a driver IC and a gate controller respectively shown in FIG. 7.

The light emitting timings of the respective light emitting elements differ from one another according to the order of the light emitting elements (the order of gate controllers connected thereto) within the respective light emitting element blocks 62a-62n. For example, the light emitting elements 62a1-62n1 emit their lights simultaneously through the gate controller 1, and, at the next timing, the light emitting elements 62a2-62n2 emit their lights simultaneously through the gate controller 2. The pitch q between the light emitting elements in the X direction which is the sub scanning moving direction of the photo conductor 1 is a distance to be covered by the photo conductor 1 when the photo conductor 1 moves in the X direction for a time between the light emitting timings of the light emitting elements.

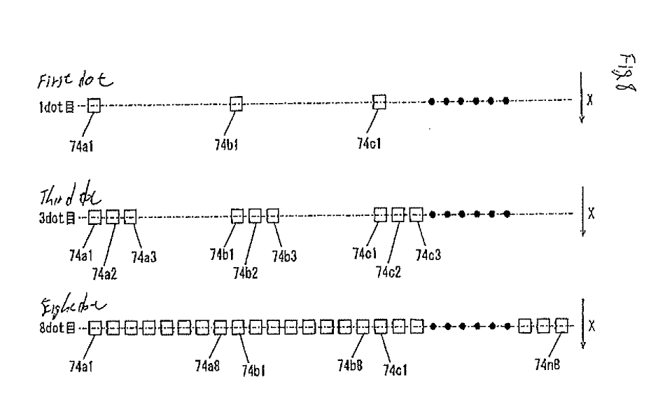

FIG. 8 is an explanatory view of toner images formed on the photo conductor 1 by the above-mentioned light emitting element array 62. Now, description will be given below of toner images on the photo conductor 1 to be formed by the light emitting elements which are arranged as shown in FIG. 6, with reference to FIG. 8. Here, for easy understanding of the explanation, description will be given below of an example in which all elements are made to emit their lights. A first dot shown in FIG. 8 represents toner images 74a1-74n1 formed on the photo conductor 1 by the elements 62a1-62n1 which have emitted their lights at the first timing of the light emitting element blocks 62a-62n.

A third dot shows toner images 74a1-74n3 formed on the photo conductor 1 by the elements 62a1-62n3 which have emitted their lights by the third timing of the light emitting element blocks 62a-62n. An eighth dot shows toner images 74a1-74n8 formed on the photo conductor 1 by the elements 62a1-62n8 which have emitted their lights by the eighth (final) timing of the light emitting element blocks 62a-62n.

As shown in FIG. 8, images exposed on the photo conductor 1 are arranged in a straight line as toner image outputs on the photo conductor 1 and, between 74a8 and 74b1 which are toner images formed by the light emitting element 62a8 and light emitting element 62b1 between the light emitting element blocks, there are formed toner images with no level difference between them.

On the other hand, when the above-described LED tips are used, for example, assuming that eight light emitting elements are formed in the LED tip (that is, an LED tip corresponds to a light emitting element block), the tip level difference will be found in every light emitting element blocks As described above as well, since the tip level difference is of the order of ±5 μm, even when trying to arrange the toner images in a straight line by controlling the above-mentioned light emitting timings, there is produced a level difference of up to 10 μm between the light emitting element blocks, so that there cannot be obtained a sufficient effect.

As has been described heretofore, in the image forming apparatus according to the embodiment 1, two or more light emitting elements within each light emitting element block arranged in the main scanning direction Y of the photo conductor 1 are previously arranged such that they are shifted downstream in the sub scanning moving direction of the photo conductor 1 according to the lags between the light emitting timings thereof, and the pitch q between the light emitting elements in the X direction is set for a value which is obtained when the pitch p between the light emitting elements in the main scanning direction Y of the photo conductor 1 is divided by the number of light emitting elements within each light emitting element block. Thanks to this, the shifting of the toner images caused by the movement of the photo conductor 1 for a time between the lags of the light emitting timings of the light emitting elements can be cancelled completely, whereby the toner images to be formed on the photo conductor 1 can be formed in a straight line. As a result of this, it is possible to obtain an image forming apparatus which can provide high image quality without increasing the cost of an optical recording head.

Also, the light emitting elements shown in FIG. 6, which range from the light emitting elements 62a1-62n1 having fast light emitting timings within the light emitting element blocks 62a-62n to the light emitting elements 62a8-62n8 having the slowest light emitting timings, are arranged such that they are shifted downstream in the sub scanning moving direction X of the photo conductor 1 while the shifting amounts thereof increase as the light emitting timings are slower. Thanks to this, without increasing the cost of the optical recording head, the toner images on the photo conductor 1 can be arranged substantially in a straight line and thus there can be obtained an image forming apparatus which can provide high image quality.

### Embodiment 2

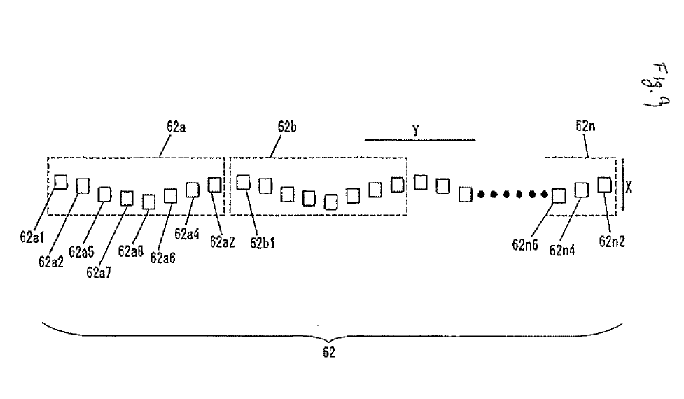

Now, FIG. 9 is an explanatory view of a light emitting element array 62 for yellow employed in an embodiment 2 according to the invention. The composing elements, functions and operations of an image forming apparatus according to the embodiment 2 as well as the image forming method thereof are similar to the image forming apparatus according to the embodiment 1 shown in FIGS. 1-7, and thus the detailed description thereof is omitted here.

The structure of the light emitting element array 62 according to the embodiment 2 is almost similar to the structure of the embodiment 1 but these two embodiments are different from each other in the arrangement manner of the light emitting elements within the light emitting element blocks. Specifically, according to the embodiment 2, the light emitting elements in the central portions of the light emitting element blocks are arranged more downstream in the sub scanning moving direction of the photo conductor than the light emitting elements in the two end portions of the blocks.

As shown in FIG. 9, the light emitting elements 62a1-62a2 are arranged in a sine curve manner. Since the arrangements of the light emitting elements within the light emitting element blocks 62a-62n are the same, description will be given below of the light emitting element block 62a and the description of the remaining light emitting element blocks is omitted here.

Referring to the arrangement of the light emitting elements within the light emitting element block 62a, the light emitting elements 62a1, 62a2, 62a3, 62a4, 62a5, 62a6, 62a7 and 62a8 are sequentially arranged in this order from the upstream side of the sub scanning moving direction X of the photo conductor 1 to the downstream side thereof; and, the light emitting timings of the respective light emitting elements 62a1-62a5 are set in the order of 62a1, 62a2, 62a3, 62a4, 62a5, 62a6, 62a7 and 62a8. A pitch in the X direction, namely, in the sub scanning moving direction of the photo conductor 1, between the light emitting elements having mutually adjoining light emitting timings is set for a distance to be covered by the photo conductor 1 when the photo conductor 1 moves for a time between the light emitting timings of the light emitting elements.

The light emitting elements 62a1-62n1 respectively disposed on one-end portions of their associated light emitting element blocks 62a-62n are arranged on a straight line in the main scanning direction Y, whereas the other remaining light emitting elements 62a2-62n8 than the light emitting elements on the above-mentioned one-end portions are arranged such that they are shifted in the sub scanning moving direction of the photo conductor 1 according to the lags between the light emitting timings of the respective light emitting elements.

When the arrangement of the light emitting elements of the light emitting block 62a as well as the light emitting timings thereof are set in the above-mentioned manner, there can also be obtained toner images similar to the toner images on the photo conductor shown in FIG. 8. What is more, since the light emitting timings of the light emitting elements (for example, 62a2 and 62b1) between the mutually adjoining light emitting element blocks are very near to each other, there can be obtained toner images which are arranged in a straight line and are higher in precision. This makes it possible to obtain an image forming apparatus which can provide high image quality.

By the way, although not shown, with respect to the light emitting elements disposed in the central portions of the light emitting element blocks, the light emitting elements disposed in the two end portions of the blocks may also be arranged shifted downstream in the sub scanning moving direction of the photo conductor.

### Embodiment 3

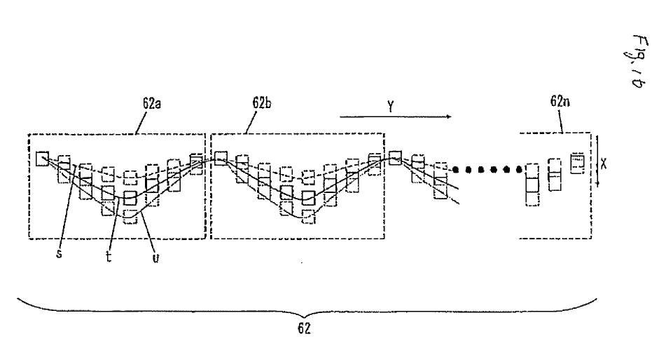

Now, FIG. 10 is an explanatory view of a light emitting array 62 for yellow employed in an embodiment 3 according to the invention. The composing elements, functions and operations of an image forming apparatus according to the embodiment 3 as well as the image forming method thereof are similar to the image forming apparatus according to the embodiment 1 shown in FIGS. 1-7, and thus the detailed description thereof is omitted here.

The structure of the light emitting element array 62 according to the embodiment 3 is almost similar to the structure of the embodiment 1 but these two embodiments are different from each other in the arrangement manner of the light emitting elements within the light emitting element blocks. Specifically, according to the embodiment 3, the light emitting elements in the central portions of the light emitting element blocks not only are arranged more downstream in the moving direction of the photo conductor than the light emitting elements in the two end portions of the blocks but also are arranged to the highest resolving power mode of the image forming apparatus.

As shown in FIG. 10, the light emitting elements within the light emitting element blocks are arranged in correspondence to the speed modes of the photo conductor 1. Since the arrangements of the light emitting elements within the light emitting element blocks 62a-62n are the same, description will be given below of the light emitting element block 62a and thus the description of the other light emitting element blocks is omitted here.

Referring to the arrangement of the light emitting elements within the light emitting element block 62a, similarly to the arrangement of the light emitting elements according to the embodiment 2, the light emitting elements 62a1, 62a2, 62a3, 62a4, 62a5, 62a6, 62a7 and 62a8 are sequentially arranged in this order from the upstream side of the sub scanning moving direction X of the photo conductor 1 to the downstream side thereof; and, the light emitting timings of the respective light emitting elements 62a1-62a8 are set in the order of 62a1, 62a2, 62a3, 62a4, 62a5, 62a6, 62a7 and 62a8. A pitch in the X direction, namely, in the sub scanning moving direction of the photo conductor 1, between the light emitting elements having mutually adjoining light emitting timings is set for a distance to be covered by the photo conductor 1 when the photo conductor 1 moves for a time between the light emitting timings of the light emitting elements.

The light emitting elements 62a1-62n1 respectively disposed in one-end portions of their associated light emitting element blocks 62a-62n are arranged on a straight line in the main scanning direction Y, whereas the other remaining light emitting elements 62a2-62n8 than the light emitting elements on the above-mentioned one-end portions are arranged such that they are shifted in the sub scanning moving direction of the photo conductor 1 according to lags between the light emitting timings of the respective light emitting elements. Where u expresses a light emitting element array in which toner images on the photo conductor 1 are arranged in a straight line when the photo conductor 1 is in the highest speed mode (standard resolving power mode), t expresses a light emitting element array in which the toner images are arranged in a straight line for the second highest speed mode, and s expresses a light emitting element array in which the toner images are arranged in a straight line for the slowest speed mode and best resolving power speed mode, a pitch between the light emitting elements in the sub scanning direction of the light emitting element array s is set for a value which can be obtained when a pitch between the light emitting elements in the main scanning direction of the photo conductor 1 is divided by the number of light emitting elements within the light emitting element block 62a. Thanks to this, the toner images in the best resolving power mode of the image forming apparatus can be formed in a straight line and thus, for the highest resolving power, the highest image quality can be obtained.

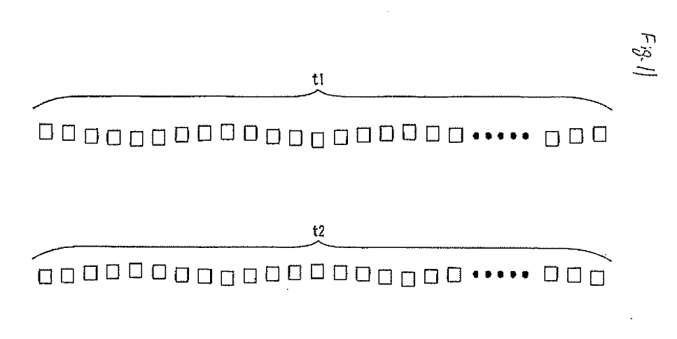

Also, the light emitting element array 62 may be the light emitting element array t (a center value between the light emitting element array u and light emitting element array s) in which the toner images are arranged in a straight line for the second highest speed mode In this case, as shown in FIG. 11, the image deterioration of the toner images t1 in the standard resolving power mode and the toner images t2 in the highest resolving power mode can be restricted to a minimum.

Also, since the light emitting array t is arranged in a sine curve manner and thus the light emitting timings of the light emitting elements (for example, 62a2 and 62b1) between the mutually adjoining light emitting element blocks are very near to each other, there can be reduced a level difference in the joints of the toner images between the mutually adjoining light emitting element blocks. This makes it possible to obtain an image forming apparatus which can provide high image quality.

When the photo conductor 1 has two or more speed modes, in the arrangement of the light emitting elements described in the embodiment 1 (see FIG. 6), for a specific speed mode, the toner images are arranged in a straight line but, for the other speed modes, there is a possibility that there can be produced a level difference in the toner images with the period of the light emitting element blocks. On the other hand, in the arrangement of the light emitting elements described in the embodiment 3 (see FIG. 10), for a specific speed mode, the toner images are arranged in a straight line and, for the other speed modes, although the toner images are not arranged in a straight line, such level difference does not occur in the toner images at all. Therefore, when the image forming apparatus has two or more speed modes, preferably, there may be employed such arrangement of the light emitting elements as has been described in the embodiment 3.

### Embodiment 4

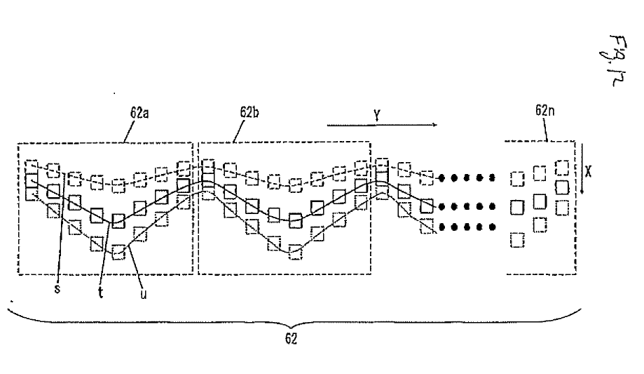

Now, FIG. 12 is an explanatory view of a light emitting array 62 for yellow employed in an embodiment 4 according to the invention. The composing elements, functions and operations of an image forming apparatus according to the embodiment 4 as well as the image forming method thereof are similar to the image forming apparatus according to the embodiment 1 shown in FIGS. 1-7, and thus the detailed description thereof is omitted here.

The structure of the light emitting element array 62 according to the embodiment 4 is almost similar to the structure of the embodiment 1 but these two embodiments are different from each other in the number of the light emitting element arrays within the light emitting element block. Specifically, the light emitting elements in the central portion of the light emitting element block are arranged more downstream in the moving direction of the photo conductor than the light emitting elements in the two end portion of the block; and, in the sub scanning direction X of the photo conductor 1, there are arranged two or more light emitting element arrays in such a manner that they correspond to the two or more speed modes of the photo conductor 1.

As shown in FIG. 12, a light emitting element array s is a light emitting element array which corresponds to the slowest moving speed mode of the photo conductor 1, a light emitting element array t is a light emitting element array which corresponds to the second fastest moving speed mode of the photo conductor 1, and a light emitting element array u is a light emitting element array which corresponds to the fastest moving speed mode of the photo conductor 1.

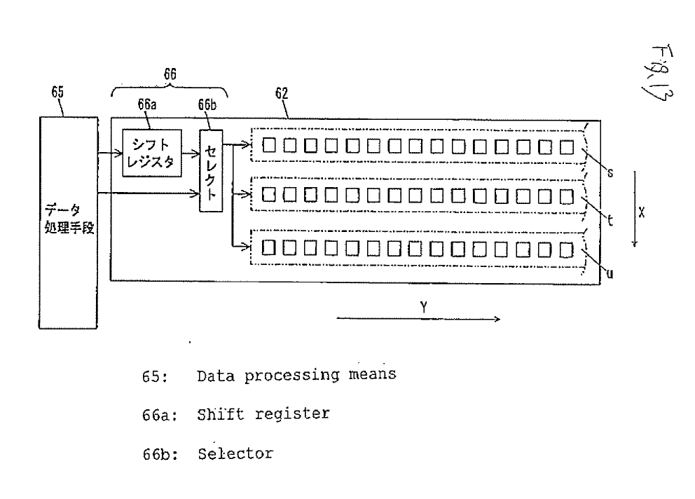

FIG. 13 is a block diagram of the schematic structure of the control parts of two or more array optical recording heads shown in FIG. 12. When image data are input from the data processing means 65 into the memory means 66, a shift register 66a transfers the image data to be exposed to a selector 66b. The image data transferred are output to a light emitting element array s by a selector 66b, thereby operating the light emitting elements of the light emitting element array s.

To operate a light emitting element array t, image data are input from the data processing means 65 into the memory means 66 and the image data to be exposed are transferred to the selector 66b by the shift register 66a. The image data transferred are output to the light emitting element array t by the selector 66b, thereby operating the light emitting elements of the light emitting element array t.

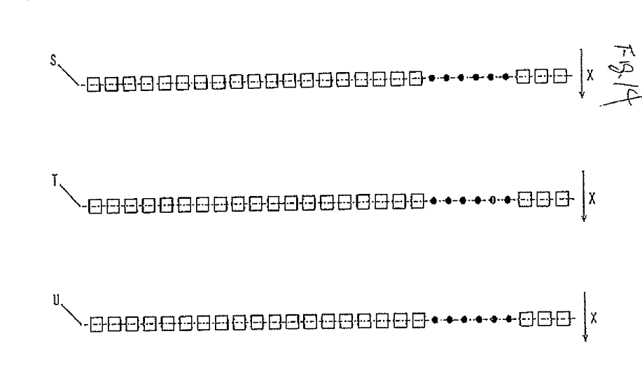

In this manner, the image data to be exposed on the photo conductor 1 are output to one of the light emitting element arrays s, t and u that is selected, thereby operating the light emitting elements of the selected light emitting element array. As shown in FIG. 14, owing to the operations of the light emitting element arrays a, t and u, there can be formed on the photo conductor 1 toner images S, T and U which are respectively arranged in a straight line, thereby being able to obtain the best image quality regardless of the moving speeds of the photo conductor 1.

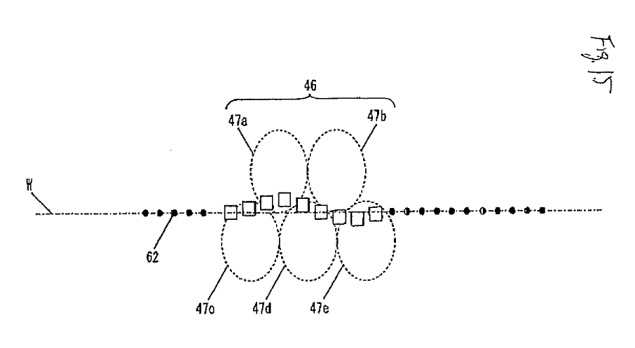

FIG. 15 is a view to show the position relationship between the lens array of an optical recording head and a light emitting element array. As shown in FIG. 15, in the lens array 46, rod lenses 47a-47e are arranged in two lines in a straw bag piling manner. The center line of the lens array 46 in the main scanning direction is coincident with the center line W of the light emitting element array 62, Owing to the above-mentioned arrangement of the lens array 46 and light emitting element array 62, even when the light emitting element array 62 is shifted in the sub scanning direction of the photo conductor 1, MTF or variations in the luminance of the light emitting elements can be restricted to a minimum, which makes it possible to prevent the deteriorated images.

In an image forming apparatus according to the invention, an optical recording head requiring a small installation area can be used without incurring the deterioration of the quality of images caused by a lag between the light emitting timings of light emitting elements. Therefore, the present image forming apparatus can be applied to a printer, a copying machine and a fax machine for business and SOHO markets, as well as to a small on-demand printing machine or the like for a small lot printing market.

This application is based upon and claims the benefit of priority of Japanese Patent Application No 2005-247122 filed on 05/08/29, the contents of which is incorporated herein by references in its entirety.

1. An image forming apparatus, comprising:
an optical recording head, having a light emitting element array including two or more sets of light emitting element blocks arranged in a main scanning direction, each block including two or more electroluminescent elements; and a photo conductor, exposable by the light from the optical recording head;
wherein the electroluminescent elements are arranged to be shifted to a sub scanning direction of the photo conductor within the light emitting element blocks; and
the emitting timing of the electroluminescent elements provided in downstream in the sub scanning direction is controlled so as to be delayed from the emitting timing of the electroluminescent elements provided in upstream in the sub scanning direction.

2. The image forming apparatus as set forth in claim 1, wherein, with respect to the electroluminescent elements arranged in one end portion of each of the light emitting element blocks, the remaining electroluminescent elements are arranged shifted downstream in the sub scanning moving direction of the photo conductor in such a manner that the downstream shifting amounts thereof increase as the arrangement positions thereof are nearer to the other end portion of each of the blocks.

3. The image forming apparatus as set forth in claim 1, wherein, with respect to the electroluminescent elements arranged in the two end portions of each of the light emitting element blocks, the electroluminescent elements arranged in the central portion of each of the blocks are disposed shifted downstream in the sub scanning moving direction of the photo conductor.

4. The image forming apparatus as set forth in claim 1, wherein, with respect to the electroluminescent elements arranged in the central portion of each of the light emitting element blocks, the electroluminescent elements arranged in the two end portions of each of the blocks are disposed shifted downstream in the sub scanning moving direction of the photo conductor.

5. The image forming apparatus as set forth in claim 1, wherein a mutually shifting amount in the sub scanning moving direction of the photo conductor between the electroluminescent elements of each light emitting element block adjoining each other in the light emitting timing order is set for a value which can be obtained when a pitch between the electroluminescent elements adjoining each other in a main scanning direction is divided by the number of the electroluminescent elements arranged within the light emitting element block.

6. The image forming apparatus as set forth in claim 1, wherein a mutually shifting amount in the sub scanning moving direction of the photo conductor between the electroluminescent elements of each light emitting element block adjoining each other in the light emitting timing order is set for a distance to be covered by the photo conductor when the photo conductor moves in the sub scanning moving direction for a time between the light emitting timings of the electroluminescent elements.

7. The image forming apparatus as set forth in claim 6, wherein the photo conductor has two or more moving speed modes and a mutually shifting amount in the sub scanning moving direction of the photo conductor between the electroluminescent elements of each light emitting element block adjoining each other in the light emitting timing order is set for a distance to be covered by the photo conductor when the photo conductor moves in the sub scanning moving direction in the slowest moving speed mode.

8. The image forming apparatus as set forth in claim 6, wherein the photo conductor has two or more moving speed modes and a mutually shifting amount in the sub scanning moving direction of the photo conductor between the electroluminescent elements of each light emitting element block adjoining each other in the light emitting timing order is set for a distance to be covered by the photo conductor when the photo conductor moves in a moving speed mode intermediate between the slowest and fastest moving speed modes in the sub scanning moving direction for a time between the light emitting timings of the electroluminescent elements.

9. The image forming apparatus as set for the in claim 6, wherein the photo conductor has two or more moving speed modes and the optical recording head includes two or more light emitting element arrays respectively corresponding to the two or more moving speed modes of the photo conductor.

10. The image forming apparatus as set forth in claim 3, wherein the light emitting element arrays are arranged in a sine curve manner.

11. The image forming apparatus as set forth in claim 1, further including a lens array for condensing the light from the light emitting arrays, wherein the center line of the lens array in the main scanning direction is coincident with the center line of the light emitting element array.

12. An image forming apparatus, comprising:
an optical recording head, having a light emitting element array with two or more sets of light emitting element blocks arranged in a main scanning direction therein, each block including two or more electroluminescent elements; and, a photo conductor exposable to the light from the optical recording head;
wherein the respective electroluminescent elements in one end portion of each of the two or more light emitting element blocks are arranged on a straight line in the main scanning direction, and the other remaining electroluminescent elements than the electroluminescent elements in one end portion of each block are arranged shifted in the sub scanning moving direction of the photo conductor according to lags between the light emitting timings of the respective electroluminescent elements.

13. An image forming apparatus, comprising:
an optical recording head having a light emitting element array with two or more sets of light emitting element blocks arranged in a main scanning direction therein, each block including two or more electroluminescent elements; and
a photo conductor, exposable to the light from the optical recording head;
wherein the respective electroluminescent elements disposed in the central portion of each of the two or more light emitting element blocks are arranged on a straight line in the main scanning direction, and the other remaining electroluminescent elements than the electroluminescent elements in the central portion of each block are arranged shifted in the sub scanning moving direction of the photo conductor according to lags between the light emitting timings of the respective electroluminescent elements.

14. The image forming apparatus as set forth in claim 1, wherein the two or more light emitting element blocks are formed collectively on a given substrate

15. The image forming apparatus as set forth in claim 4, wherein the light emitting element arrays are arranged in a sine curve manner.

16. The image forming apparatus as set forth in claim 12, wherein the two or more light emitting element blocks are formed collectively on a given substrate.

17. The image forming apparatus as set forth in claim 13, wherein the two or more light emitting element blocks are formed collectively on a given substrate.
